(19) United States
(12) Patent Application Publication
(10) Pub. No.: US 2025/0392632 A1
(43) Pub. Date: Dec. 25, 2025

(54) METHOD FOR MEDIA STREAM PROCESSING, ELECTRONIC DEVICE, AND MEDIUM

(71) Applicant: Beijing Zitiao Network Technology Co., Ltd., Haidian District (CN)

(72) Inventors: Huanqiang XU, Beijing (CN); Wenfeng LI, Beijing (CN)

(21) Appl. No.: 19/181,718

(22) Filed: Apr. 17, 2025

(30) Foreign Application Priority Data
May 23, 2024 (CN) 202410644864.0

(51) Int. Cl. H04L 65/75; H04L 65/65

(52) U.S. Cl. CPC H04L 65/765; H04L 65/65

(57) ABSTRACT

The present disclosure provides a method for media stream processing, an electronic device, and a medium. And the method includes: receiving a media stream, where the media stream includes an audio stream and a video stream that are transmitted through different channels; determining, in response to triggering of a preset event, a time difference between the audio stream and the video stream that are included in the media stream; obtaining buffer information of the media stream; and adjusting a size of a buffer of the media stream based on the time difference and the buffer information, such that the audio stream and the video stream that are included in the media stream are played back synchronously. The implementation efficiently achieves the effect of audio-video synchronization without incurring substantial performance overhead.

### CROSS-REFERENCE TO RELATED APPLICATION

The present application claims priority and benefits to a Chinese patent application No. 202410644864.0, filed on May 23, 2024. The full content of the above Chinese patent application is hereby incorporated by reference as a part of the present application.

### TECHNICAL FIELD

The present disclosure relates to a method for media stream processing, an electronic device, and a medium.

### BACKGROUND

With the continuous development of streaming media technology, streaming media are increasingly widely used in people's work, study, and life. For example, in a scenario of online video conferencing or live broadcast, a user needs to hear audio while also seeing visuals, thus requiring simultaneous transmission of both audio and video. However, the user has different needs regarding audio and video. For example, the user needs to hear all sounds or the loudest sound, but may selectively view the visuals. Therefore, the audio and the video are transmitted independently through different channels. The independent transmission of the audio and the video results in a problem that the audio and the video are out of synchronization during playback. In addition, the user may switch between different visuals in the same scenario, or a server may switch between different audio in the same scenario as required. Therefore, a synchronization relationship between audio and video needs to be adjusted based on these switches of the audio or video. Currently, there is a need for a solution for audio-video synchronization.

### SUMMARY

The present disclosure provides a method for media stream processing, an apparatus, an electronic device and a medium.

An embodiment of the present disclosure provides a method for media stream processing. The method includes:
receiving a media stream, the media stream including an audio stream and a video stream that are transmitted through different channels;
determining, in response to triggering of a preset event, a time difference between the audio stream and the video stream that are included in the media stream;
obtaining buffer information of the media stream; and
adjusting a size of a buffer of the media stream based on the time difference and the buffer information, such that the audio stream and the video stream that are included in the media stream are played back synchronously.

An embodiment of the present disclosure provides a media stream processing apparatus is provided. The apparatus includes:
a receiving module, configured to receive a media stream, where the media stream includes an audio stream and a video stream that are transmitted through different channels;
a determining module configured to determine, in response to triggering of a preset event, a time difference between the audio stream and the video stream that are included in the media stream;
an obtaining module configured to obtain buffer information of the media stream; and
an adjustment module configured to adjust a size of a buffer of the media stream based on the time difference and the buffer information, such that the audio stream and the video stream that are included in the media stream are played back synchronously.

An embodiment of the present disclosure provides, a computer-readable storage medium. The storage medium stores a computer program, where the computer program, when executed by a processor, causes the processor to implement the method described in any one of the above.

According to a fourth aspect, an electronic device is provided. The electronic device includes a memory, a processor, and a computer program stored on the memory and executable by the processor, where the program, when executed by the processor, causes the processor to implement the method described in any one of the above.

### BRIEF DESCRIPTION OF DRAWINGS

To describe the technical solutions in the embodiments of the specification more clearly, the accompanying drawings for describing the embodiments are briefly described below. Apparently, the accompanying drawings in the following descriptions are merely some embodiments described in the specification, and a person of ordinary skill in the art may still derive other accompanying drawings from these accompanying drawings without creative efforts.

FIG. 1 is a schematic diagram of an application scenario of media stream processing according to an exemplary embodiment of the present disclosure;

FIG. 2 is a flowchart of a method for media stream processing according to an exemplary embodiment of the present disclosure;

FIG. 3 is a block diagram of a media stream processing apparatus according to an exemplary embodiment of the present disclosure;

FIG. 4 is a schematic block diagram of an electronic device according to some embodiments of the present disclosure;

FIG. 5 is a schematic block diagram of another electronic device according to some embodiments of the present disclosure; and

FIG. 6 is a schematic diagram of a storage medium according to some embodiments of the present disclosure.

### DETAILED DESCRIPTION

To make a person skilled in the art better understand the technical solutions of the specification, the technical solutions in the embodiments of the specification are described clearly below with reference to the accompanying drawings in the embodiments of the specification. Apparently, the described embodiments are merely some rather than all of the embodiments of the specification. All other embodiments obtained by a person of ordinary skill in the art based on the embodiments of the specification without creative efforts shall fall within the scope of protection of the specification.

When the following description involves the accompanying drawings, the same numerals in different accompanying drawings denote the same or similar elements, unless otherwise indicated. The implementations described in the following exemplary embodiments do not represent all the implementations consistent with the present disclosure. Rather, these implementations are merely examples of apparatuses and methods that are consistent with some aspects of the present disclosure and that are described in detail in the appended claims.

Terms used in the present disclosure are used only to describe specific embodiments rather than limit the present disclosure. Singular forms “a”, “said”, and “the” used in the present disclosure are also intended to include plural forms unless the context clearly indicates otherwise. It should be further understood that the term “and/or” used herein refers to any or all possible combinations including one or more associated listed items.

It should be understood that although the terms “first”, “second”, “third”, and the like may be used in the present disclosure to describe various information, the information should not be limited to these terms. These terms are used only to distinguish the same type of information from each other. For example, without departing from the scope of the present disclosure, first information may also be referred to as second information, and similarly, second information may also be referred to as first information. Depending on the context, for example, the term “if” used herein may be explained as “when” or “while” or “in response to . . . , it is determined that”.

With the continuous development of streaming media technology, streaming media are increasingly widely used in people's work, study, and life. For example, in a scenario of online video conferencing or live broadcast, a user needs to hear audio while also seeing visuals, thus requiring simultaneous transmission of both audio and video. However, the user has different needs regarding audio and video. For example, the user needs to hear all sounds or the loudest sound, but may selectively view the visuals. Therefore, the audio and the video are transmitted independently through different channels. The independent transmission of the audio and the video results in a problem that the audio and the video are out of synchronization during playback. In addition, the user may switch between different visuals in the same scenario, or a server may switch between different audio in the same scenario as required. Therefore, a synchronization relationship between audio and video needs to be adjusted based on these switches of the audio or video.

In the related art, audio-video synchronization is usually performed by modifying code inside a client player. However, performing the audio-video synchronization by modifying the code inside the client player has certain limitations. For example, for a player of a web side, that is, Web real-time communications (WebRTC), the audio-video synchronization cannot be performed by modifying code. However, in some other related technologies, for the WebRTC, a synchronization relationship between an audio and a video may be set through a SetRemoteSdp interface provided by the WebRTC, to perform the audio-video synchronization. However, this operation incurs significant performance overhead.

According to a method for media stream processing provided in the present disclosure, a time difference between an audio stream and a video stream that are included in a received media stream is determined, buffer information of the media stream is obtained, and a size of a buffer of the media stream is adjusted based on the time difference and the buffer information, such that the audio stream and the video stream that are included in the media stream can be played back synchronously. Without incurring substantial performance overhead, the effect of audio-video synchronization is efficiently achieved.

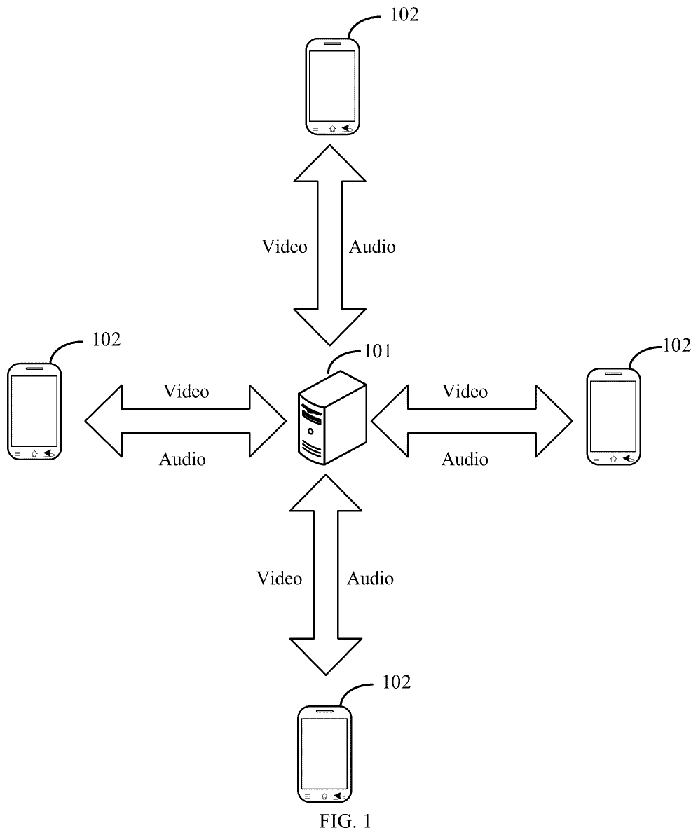

Refer to FIG. 1, which is a schematic diagram of an application scenario of media stream processing according to an exemplary embodiment of the present disclosure.

As shown in FIG. 1, an application scenario of video conferencing is used as an example, a device 101 is a media server held by a service provider, and a device 102 is a client device held by a user. The client device establishes a communication connection to the media server through a network, and each client device may separately upload video data and audio data collected by the client device to the media server. After receiving a plurality of pieces of audio data and a plurality of pieces of video data uploaded by all the client devices, the media server delivers at least one audio stream to each client device after analysis and aggregation. Based on different requests of different users, a corresponding video stream is delivered to the client device held by each user. After receiving the video stream and the audio stream, each client device may perform an audio-video synchronization operation, such that the video stream and the audio stream can be played back synchronously.

In addition, the characteristics, for example, the strength, of an audio uploaded by each client device may change with time, and the user may also switch videos as required. Therefore, the media server also continuously update, according to the actual situation, the delivered audio stream and video stream. Each time the delivered audio or video stream is updated, the client device needs to perform the audio-video synchronization, such that the updated video stream and audio stream can be played back synchronously.

The present disclosure is described in detail below with reference to specific embodiments.

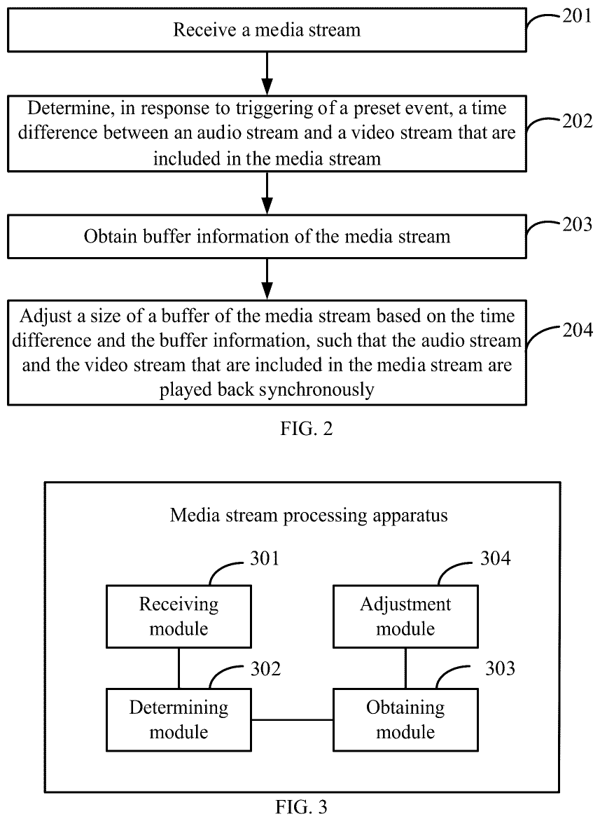

FIG. 2 is a flowchart of a method for media stream processing according to an exemplary embodiment. The method may be applied to a terminal device. In this embodiment, for ease of understanding, descriptions are provided by using an example in combination with a terminal device on which a media data playback client can be installed. A person skilled in the art may understand that the terminal device may include, but is not limited to, a mobile terminal device such as a smartphone, a tablet computer, a notebook computer, a desktop computer, and the like. The method may include the following steps.

As shown in FIG. 2, in step 201, a media stream is received.

In this embodiment, the terminal device may receive a media stream sent by a media server, the media stream may include an audio stream and a video stream, and the audio stream and the video stream are transmitted through different channels. For example, video conferencing is used as an example, clients of participating users may respectively collect their own video data and audio data, and upload the video data and the audio data to the media server. After analysis and aggregation, the media server may uniformly deliver at least one audio stream to each client device based on a characteristic, such as the sound strength, of an audio. When the characteristic, such as the sound strength, of the audio uploaded by the users changes, the media server re-adjusts the audio stream to be delivered to the client devices.

For example, the media server receives an audio stream Y1 uploaded by a user A by using a client, an audio stream Y2 uploaded by a user B by using a client, and an audio stream Y3 uploaded by a user C by using a client. The media server may determine, by analyzing the audio stream, that the sound strength corresponding to the audio stream Y1 is the highest. Therefore, the media server may deliver the audio stream Y1 to each client. At a certain moment, the sound strength corresponding to the audio stream Y2 becomes the highest, and then the media server may switch from the audio stream Y1 to the audio stream Y2, and deliver the audio stream Y2 to each client.

In addition, the media server may deliver, based on audio data by default together, a video corresponding to an audio with the highest sound strength to each client. The user of the client may alternatively choose by themselves to request the media server for a video the user intends to play back, and the media server may deliver, based on a request of the user to the client held by the user, a video stream selected by the user.

For example, when delivering the audio stream Y1 to each client, the media server also delivers, to each client by default together, a video stream S1 uploaded by the user A by using the client. When switching from the audio stream Y1 to the audio stream Y2 and delivering the audio stream Y2 to each client, the media server also delivers, to each client by default together, a video stream S2 uploaded by the user B by using the client. In addition, when the user A requests, by using the client, to select a video stream S3 uploaded by C by using the client, the media server may deliver the video stream S3 to the client of the user A exclusively.

In step 202, a time difference between the audio stream and the video stream that are included in the media stream is determined in response to triggering of a preset event.

In this embodiment, triggered by the preset event, the client may determine the time difference between the audio stream and the video stream that are included in the media stream. The preset event may be that the media server updates the to-be-delivered audio stream. For example, the media server first delivers the audio stream Y1 corresponding to the user A to each client, and the preset event may be an event that the media server updates the audio stream Y1 delivered to the client to the audio stream Y2 corresponding to the user B.

The preset event may alternatively be that the media server updates a to-be-delivered video stream. For example, the media server first delivers the video stream S1 corresponding to the user A to the client of the user B, and the preset event may be an event that the media server updates the video stream S1 delivered to the client of the user B to the video stream S3 corresponding to the user C.

The preset event may alternatively be an arrival time of every preset time period, for example, every n seconds. An arrival time of the n seconds is used as the time for triggering the preset event. It may be understood that this embodiment does not impose limitations on the specific settings of the preset event.

In this embodiment, the time difference between the audio stream and the video stream that are included in the media stream may be determined in response to triggering of the preset event. Specifically, first, a first data packet of the current audio stream and a second data packet of the current video stream may be determined. For example, the client may use the last audio data packet received prior to the current moment as the first data packet of the current audio stream; and use the last video data packet received prior to the current moment as the second data packet of the current video stream.

Then, a first collection time corresponding to the first data packet and a second collection time corresponding to the second data packet may be obtained. A first reception time corresponding to the first data packet and a second reception time corresponding to the second data packet are obtained. Specifically, a collection time may be obtained from a preset field of a data packet, and a reception time is obtained through an interface provided by the client. Optionally, the method may be applied to a player of a web side. Therefore, the first collection time may be obtained from an extension field of the first data packet and the second collection time may be obtained from an extension field of the second data packet through a first interface provided by the web side. In addition, the first reception time and the second reception time are obtained through a second interface provided by the web side.

For example, when delivering a data packet (an audio data packet or a video data packet) to the client, the media server may add, to the delivered data packet, an extension field for recording the collection time. After receiving the data packet, the player of the web side may use an RTCRtpReceiver.getSynchronizationSources interface as the first interface, to obtain, through the first interface, the collection time recorded in the extension field of the data packet; and in addition, may further obtain, through the first interface, a reception time when the client receives the data packet.

Then, the time difference may be calculated based on the first collection time, the second collection time, the first reception time, and the second reception time. Specifically, a first time interval between the first collection time and the first reception time may be calculated, a second time interval between the second collection time and the second reception time may be calculated, and a first difference between the first time interval and the second time interval may be determined as the time difference.

For example, the first collection time may be denoted as tc1, the second collection time may be denoted as tc2, the first reception time may be denoted as tr1, the second reception time may be denoted as tr2, and the time difference may be denoted as Δt. The following relational expression can be obtained:

$$Δ t = ( tr 1 - tc 1 ) - ( t r 2 - t c 2 )$$

In step 203, buffer information of the media stream is obtained. In step 204, a size of a buffer of the media stream is adjusted based on the time difference and the buffer information, such that the audio stream and the video stream that are included in the media stream are played back synchronously.

In this embodiment, the buffer information of the media stream may be obtained, and the size of the buffer of the media stream may be adjusted in combination with the buffer information and the time difference. Specifically, in an implementation, a buffer of the video stream may be used as a reference, and a size of a buffer of the audio stream is controlled, to implement audio-video synchronization.

In another implementation, a buffer of the audio stream may alternatively be used as a reference, and a size of a buffer of the video stream is controlled, to implement the audio-video synchronization. Specifically, when the method is applied to the player of the web side, a buffer duration of a plurality of data packets corresponding to the audio stream in the media stream within a preset time period in the buffer may be obtained through the second interface provided by the web side, and an average buffer duration of the plurality of data packets in the buffer is calculated as the buffer information of the media stream.

For example, an RTCRtpReceive.getStat interface provided by the web side may be used as the second interface, and the buffer information of the media stream is determined through the second interface. Specifically, an RTCInboundRtpStreamStats structure of the media stream may be obtained through the second interface, and the structure includes a jitterBufferDelay field and a jitterBufferEmittedCount field. After receiving the audio data packet, the client puts the audio data packet into the buffer, and takes the audio data packet out of the buffer after a time period. The duration for which the audio data packet is stored in the buffer may be recorded in the jitterBufferDelay field, and a value of the jitterBufferEmittedCount field may be incremented by one. Through the second interface, a total duration T for which audio data packets m to n are stored in the buffer may be obtained from the jitterBufferDelay field, and a total quantity N of data packets from the audio data packet m to the audio data packet n may be obtained from the jitterBufferEmittedCount field. Based on the total duration T and the total quantity N, an average buffer duration for which each audio data packet is stored in the buffer is calculated as the buffer information of the media stream.

Finally, the size of the buffer of the media stream may be adjusted based on the time difference and the buffer information, such that the audio stream and the video stream that are included in the media stream are played back synchronously. For example, the size of the buffer of the video stream may be adjusted based on the time difference and the average buffer duration of the audio stream. Specifically, a sum of the average buffer duration and the time difference may be calculated as an adjustment parameter, and the size of the buffer corresponding to the video stream in the media stream may be adjusted by using the adjustment parameter.

For example, the above average buffer duration may be denoted as δ, the above time difference may be denoted as Δt, and the adjustment parameter may be denoted as K. The following relational expression can be obtained:

$$K = Δ t + δ$$

The size of the buffer corresponding to the video stream in the media stream may be adjusted by using K, such that K+(tr2−tc2)=(tr1−tc1)+δ, where K may be an average buffer duration for which each video packet is stored in the buffer.

Specifically, the size of the buffer of the media stream may be set through a third interface provided by the web side. For example, an RTCRtpReceiver.playoutDelayHint interface provided by the web side may be used as the third interface, and K may be set into the third interface, such that the size of the buffer of the video stream can be controlled.

According to the method for media stream processing provided in the present disclosure, the time difference between the audio stream and the video stream that are included in the received media stream is determined, the buffer information of the media stream is obtained, and the size of the buffer of the media stream is adjusted based on the time difference and the buffer information, such that the audio stream and the video stream that are included in the media stream can be played back synchronously. Without incurring substantial performance overhead, the effect of audio-video synchronization is efficiently achieved.

It should be noted that although in the above embodiments, the operations of the method of the embodiments of the present disclosure are described in a particular sequence, this does not require or imply that these operations must be performed in the particular sequence, or that all of the operations shown must be performed to implement the desired result. On the contrary, the steps described in the flowcharts may change in execution sequence. Additionally or alternatively, some steps may be omitted, multiple steps may be combined into one step for execution, and/or one step may be decomposed into multiple steps for execution.

Corresponding to the above embodiment of the method for media stream processing, the present disclosure further provides an embodiment of a media stream processing apparatus.

As shown in FIG. 3, which is a block diagram of a media stream processing apparatus according to an exemplary embodiment of the present disclosure, the apparatus may include: a receiving module 301, a determining module 302, an obtaining module 303, and an adjustment module 304.

The receiving module 301 is configured to receive a media stream. The media stream includes an audio stream and a video stream that are transmitted through different channels.

The determining module 302 is configured to determine, in response to triggering of a preset event, a time difference between the audio stream and the video stream that are included in the media stream.

The obtaining module 303 is configured to obtain buffer information of the media stream.

The adjustment module 304 is configured to adjust a size of a buffer of the media stream based on the time difference and the buffer information, such that the audio stream and the video stream that are included in the media stream are played back synchronously.

In some implementations, the determining module 302 is configured to: determine a first data packet of the current audio stream and a second data packet of the current video stream, obtain a first collection time corresponding to the first data packet and a second collection time corresponding to the second data packet, obtain a first reception time corresponding to the first data packet and a second reception time corresponding to the second data packet, and calculate a time difference based on the first collection time, the second collection time, the first reception time, and the second reception time.

In some other implementations, the method is applied to a web side. The determining module 302 may obtain the first collection time corresponding to the first data packet and the second collection time corresponding to the second data packet by: obtaining the first collection time from an extension field of the first data packet and the second collection time from an extension field of the second data packet through a first interface provided by the web side.

The determining module 302 may obtain the first reception time corresponding to the first data packet and the second reception time corresponding to the second data packet by: obtaining the first reception time and the second reception time through the first interface.

In some other implementations, the determining module 302 may calculate the time difference based on the first collection time, the second collection time, the first reception time, and the second reception time by: calculating a first time interval between the first collection time and the first reception time, calculating a second time interval between the second collection time and the second reception time, and determining a difference between the first time interval and the second time interval as the time difference.

In some other implementations, the method is applied to the web side, and the obtaining module 303 is configured to: obtain a buffer duration of a plurality of data packets corresponding to the audio stream in the media stream within a preset time period in the buffer through a second interface provided by the web side, and calculate an average buffer duration of the plurality of data packets in the buffer as the buffer information.

In some other implementations, the adjustment module 304 is configured to: calculate a sum of the average buffer duration and the time difference as an adjustment parameter, and adjust, by using the adjustment parameter, a size of a buffer corresponding to the video stream in the media stream.

In some other implementation, the adjustment module 304 may adjust, using the adjustment parameter, the size of the buffer corresponding to the video stream in the media stream by: setting the size of the buffer of the media stream by using the adjustment parameter through a third interface provided by the web side.

The apparatus embodiment is substantially corresponding to the method embodiment, and therefore for a related part, reference may be made to the descriptions of the part in the method embodiment. The apparatus embodiment described above is merely schematic, where the units described as separated components may or may not be physically separated, and the components displayed as units may or may not be physical units, that is, may be located at one position or may be distributed to a plurality of network units. Some or all of the modules may be selected according to actual needs to implement the objectives of the solutions of the embodiments of the present disclosure, which can be understood and implemented by those of ordinary skill in the art without involving any inventive effort.

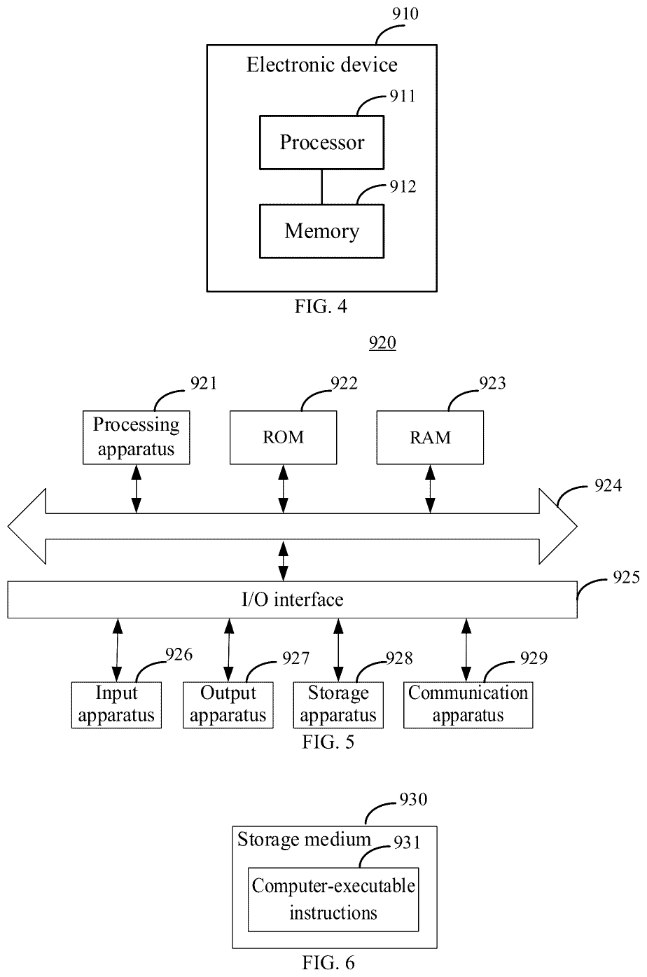

FIG. 4 is a schematic block diagram of an electronic device according to some embodiments of the present disclosure. As shown in FIG. 4, the electronic device 910 includes a processor 911 and a memory 912, and may be configured to implement a client or a server. The memory 912 is configured to store computer-executable instructions (for example, one or more computer program modules) in a non-transitory manner. The processor 911 is configured to run the computer-executable instructions. When the computer-executable instructions are run by the processor 911, one or more steps of the method for media stream processing described above may be performed, thereby implementing the method for media stream processing described above. The memory 912 and the processor 911 may be interconnected by using a bus system and/or a connection mechanism (not shown) in another form.

The processor 911 may be, for example, a central processing unit (CPU), a graphics processing unit (GPU), or other form of processing unit having data processing capabilities and/or program execution capabilities. The central processing unit (CPU) may have an X86 or ARM architecture or the like. The processor 911 may be a general-purpose processor or a special-purpose processor, and may control other components in the electronic device 910 to perform desired functions.

For example, the memory 912 may include any combination of one or more computer program products, which may include various forms of computer-readable storage media, such as a volatile memory and/or a non-volatile memory. The volatile memory may include, for example, a random access memory (RAM) and/or a cache memory (cache). The non-volatile memory may include, for example, a read-only memory (ROM), a hard disk, an erasable programmable read-only memory (EPROM), a portable compact disk read-only memory (CD-ROM), a USB flash drive, and a flash memory. The computer-readable storage medium may store one or more computer program modules, and the processor 911 may run the one or more computer program modules to implement the various functions of the electronic device 910. The computer-readable storage medium may further store various applications, various data, various data used and/or generated by the applications, and the like.

It should be noted that for the specific function and technical effects of the electronic device 910 in the embodiments of the present disclosure, reference may be made to the above descriptions of the method for media stream processing, and details will not be elaborated further.

FIG. 5 is a schematic block diagram of another electronic device according to some embodiments of the present disclosure. The electronic device 920 is, for example, adapted to implement the method for media stream processing provided in the embodiments of the present disclosure. The electronic device 920 may be a terminal device or the like, and may be configured to implement a client or a server. The electronic device 920 may include, but is not limited to, a mobile terminal such as a mobile phone, a notebook computer, a digital broadcast receiver, a personal digital assistant (PDA), a tablet computer (PAD), a portable multimedia player (PMP), a vehicle-mounted terminal (such as a vehicle navigation terminal), and a wearable electronic device, and a fixed terminal such as a digital TV, a desktop computer, and a smart home device. It should be noted that the electronic device 920 shown in FIG. 5 is merely an example, and does not impose any limitation on the function and scope of use of the embodiments of the present disclosure.

As shown in FIG. 5, the electronic device 920 may include a processing apparatus (e.g., a central processing unit or a graphics processing unit) 921 that may perform a variety of appropriate actions and processing in accordance with a program stored in a read-only memory (ROM) 922 or a program loaded from a storage apparatus 928 into a random access memory (RAM) 923. The RAM 923 further stores various programs and data required for the operation of the electronic device 920. The processing apparatus 921, the ROM 922, and the RAM 923 are connected to one another through a bus 924. An input/output (I/O) interface 925 is also connected to the bus 924.

Generally, the following apparatuses may be connected to the I/O interface 925: an input apparatus 926 including, for example, a touchscreen, a touchpad, a keyboard, a mouse, a camera, a microphone, an accelerometer, and a gyroscope; an output apparatus 927 including, for example, a liquid crystal display (LCD), a speaker, and a vibrator; the storage apparatus 928 including, for example, a tape and a hard disk; and a communication apparatus 929. The communication apparatus 929 may allow the electronic device 920 to perform wireless or wired communication with other electronic devices to exchange data. Although FIG. 5 shows the electronic device 920 having various apparatuses, it should be understood that it is not required to implement or have all of the shown apparatuses, and the electronic device 920 may alternatively implement or have more or fewer devices.

For example, according to an embodiment of the present disclosure, the foregoing method for media stream processing may be implemented as a computer software program. For example, an embodiment of the present disclosure includes a computer program product, including a computer program carried on a non-transitory computer-readable medium. The computer program includes program code for performing the foregoing method for media stream processing. In such an embodiment, the computer program may be downloaded and installed from a network through the communication apparatus 929, installed from the storage apparatus 928, or installed from the ROM 922. The computer program, when executed by the processing apparatus 921, may cause the functions defined in the method for media stream processing provided in the embodiments of the present disclosure to be implemented.

FIG. 6 is a schematic diagram of a storage medium according to some embodiments of the present disclosure. For example, as shown in FIG. 6, the storage medium 930 may be a non-transitory computer-readable storage medium for storing non-transitory computer-executable instructions 931. The non-transitory computer-executable instructions 931, when executed by a processor, may cause the processor to implement the method for media stream processing described in the embodiments of the present disclosure. For example, the non-transitory computer-executable instructions 931, when executed by a processor, may cause the processor to perform one or more of steps of the method for media stream processing described above.

For example, the storage medium 930 may be applied to the electronic device. For example, the storage medium 930 may include a memory in the electronic device.

For example, the storage medium may include a memory card of a smartphone, a storage component of a tablet computer, a hard disk of a personal computer, a random access memory (RAM), a read-only memory (ROM), an erasable programmable read-only memory (EPROM), a portable compact disk read-only memory (CD-ROM), a flash memory, or any combination of the above storage media, or may be other suitable storage media.

For example, for the description of the storage medium 930, reference may be made to the description of the memory in the embodiments of the electronic device, and details of the same parts will not be elaborated further. For the specific function and technical effects of the storage medium 930, reference may be made to the above descriptions of the method for media stream processing, and details will not be elaborated further.

It should be noted that in the context of the present disclosure, a computer-readable medium may be a tangible medium that may contain or store a program used by or in combination with an instruction execution system, apparatus, or device. The computer-readable medium may be a computer-readable signal medium, a computer-readable storage medium, or any combination thereof. Examples of the computer-readable storage medium may include, but are not limited to: electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

A person skilled in the art may readily figure out other implementation solutions of the present disclosure after considering the specification and practicing the invention disclosed herein. The present disclosure is intended to cover any variations, uses or adaptive changes of the present disclosure. These variations, uses or adaptive changes follow the general principle of the present disclosure and include common general knowledge or conventional technical means in the art which is not disclosed in the present disclosure. The specification and embodiments are merely considered as examples, and the true scope and spirit of the disclosure are defined by the claims.

It should be understood that the present disclosure is not limited to the exact structure that has been described above and shown in the accompanying drawings, and various modifications and changes may be made without departing from the scope of the present disclosure. The scope of the present disclosure is limited by the appended claims only.

1. A method for media stream processing, comprising:
receiving a media stream, wherein the media stream comprises an audio stream and a video stream that are transmitted through different channels;
determining, in response to triggering of a preset event, a time difference between the audio stream and the video stream that are comprised in the media stream;
obtaining buffer information of the media stream; and
adjusting a size of a buffer of the media stream based on the time difference and the buffer information, such that the audio stream and the video stream that are comprised in the media stream are played back synchronously.

2. The method according to claim 1, wherein the determining a time difference between the audio stream and the video stream that are comprised in the media stream comprises:
determining a first data packet of the current audio stream and a second data packet of the current video stream;
obtaining a first collection time corresponding to the first data packet and a second collection time corresponding to the second data packet;
obtaining a first reception time corresponding to the first data packet and a second reception time corresponding to the second data packet; and
calculating the time difference based on the first collection time, the second collection time, the first reception time, and the second reception time.

3. The method according to claim 2, wherein the obtaining a first collection time corresponding to the first data packet and a second collection time corresponding to the second data packet comprises:
obtaining the first collection time from an extension field of the first data packet and the second collection time from an extension field of the second data packet through a first interface provided by a web side,
wherein the obtaining a first reception time corresponding to the first data packet and a second reception time corresponding to the second data packet comprises:
obtaining the first reception time and the second reception time through the first interface.

4. The method according to claim 2, wherein the calculating the time difference based on the first collection time, the second collection time, the first reception time, and the second reception time comprises:
calculating a first time interval between the first collection time and the first reception time;
calculating a second time interval between the second collection time and the second reception time; and
determining a difference between the first time interval and the second time interval as the time difference.

5. The method according to claim 1, wherein the obtaining buffer information of the media stream comprises:
obtaining a buffer duration of a plurality of data packets corresponding to the audio stream in the media stream in the buffer within a preset time period through a second interface provided by a web side; and
calculating an average buffer duration of the plurality of data packets in the buffer as the buffer information.

6. The method according to claim 5, wherein the adjusting a size of a buffer of the media stream based on the time difference and the buffer information comprises:
calculating a sum of the average buffer duration and the time difference as an adjustment parameter; and
adjusting, by using the adjustment parameter, a size of a buffer corresponding to the video stream in the media stream.

7. The method according to claim 6, wherein the adjusting, by using the adjustment parameter, a size of a buffer corresponding to the video stream in the media stream comprises:
setting the size of the buffer of the media stream by using the adjustment parameter through a third interface provided by the web side.

8. A non-transitory computer-readable storage medium storing a computer program, wherein the computer program, when executed in a computer, causes the computer to perform a method for media stream processing, wherein the method comprises:
receiving a media stream, wherein the media stream comprises an audio stream and a video stream that are transmitted through different channels;
determining, in response to triggering of a preset event, a time difference between the audio stream and the video stream that are comprised in the media stream;
obtaining buffer information of the media stream; and
adjusting a size of a buffer of the media stream based on the time difference and the buffer information, such that the audio stream and the video stream that are comprised in the media stream are played back synchronously.

9. The non-transitory computer-readable storage medium according to claim 8, wherein the determining a time difference between the audio stream and the video stream that are comprised in the media stream comprises:
determining a first data packet of the current audio stream and a second data packet of the current video stream;
obtaining a first collection time corresponding to the first data packet and a second collection time corresponding to the second data packet;
obtaining a first reception time corresponding to the first data packet and a second reception time corresponding to the second data packet; and
calculating the time difference based on the first collection time, the second collection time, the first reception time, and the second reception time.

10. The non-transitory computer-readable storage medium according to claim 9, wherein the obtaining a first collection time corresponding to the first data packet and a second collection time corresponding to the second data packet comprises:
obtaining the first collection time from an extension field of the first data packet and the second collection time from an extension field of the second data packet through a first interface provided by a web side,
wherein the obtaining a first reception time corresponding to the first data packet and a second reception time corresponding to the second data packet comprises:
obtaining the first reception time and the second reception time through the first interface.

11. The non-transitory computer-readable storage medium according to claim 9, wherein the calculating the time difference based on the first collection time, the second collection time, the first reception time, and the second reception time comprises:
calculating a first time interval between the first collection time and the first reception time;
calculating a second time interval between the second collection time and the second reception time; and
determining a difference between the first time interval and the second time interval as the time difference.

12. The non-transitory computer-readable storage medium according to claim 8, wherein the obtaining buffer information of the media stream comprises:
obtaining a buffer duration of a plurality of data packets corresponding to the audio stream in the media stream in the buffer within a preset time period through a second interface provided by a web side; and
calculating an average buffer duration of the plurality of data packets in the buffer as the buffer information.

13. The non-transitory computer-readable storage medium according to claim 12, wherein the adjusting a size of a buffer of the media stream based on the time difference and the buffer information comprises:
calculating a sum of the average buffer duration and the time difference as an adjustment parameter; and
adjusting, by using the adjustment parameter, a size of a buffer corresponding to the video stream in the media stream.

14. An electronic device, comprising a memory and a processor, wherein the memory stores executable code, and the processor, when executing the executable code, implements a method for media stream processing, wherein the method comprises:
receiving a media stream, wherein the media stream comprises an audio stream and a video stream that are transmitted through different channels;
determining, in response to triggering of a preset event, a time difference between the audio stream and the video stream that are comprised in the media stream;
obtaining buffer information of the media stream; and
adjusting a size of a buffer of the media stream based on the time difference and the buffer information, such that the audio stream and the video stream that are comprised in the media stream are played back synchronously.

15. The electronic device according to claim 14, wherein the determining a time difference between the audio stream and the video stream that are comprised in the media stream comprises:
determining a first data packet of the current audio stream and a second data packet of the current video stream;
obtaining a first collection time corresponding to the first data packet and a second collection time corresponding to the second data packet;
obtaining a first reception time corresponding to the first data packet and a second reception time corresponding to the second data packet; and
calculating the time difference based on the first collection time, the second collection time, the first reception time, and the second reception time.

16. The electronic device according to claim 15, wherein the obtaining a first collection time corresponding to the first data packet and a second collection time corresponding to the second data packet comprises:
obtaining the first collection time from an extension field of the first data packet and the second collection time from an extension field of the second data packet through a first interface provided by a web side,
wherein the obtaining a first reception time corresponding to the first data packet and a second reception time corresponding to the second data packet comprises:
obtaining the first reception time and the second reception time through the first interface.

17. The electronic device according to claim 15, wherein the calculating the time difference based on the first collection time, the second collection time, the first reception time, and the second reception time comprises:
calculating a first time interval between the first collection time and the first reception time;
calculating a second time interval between the second collection time and the second reception time; and
determining a difference between the first time interval and the second time interval as the time difference.

18. The electronic device according to claim 14, wherein the obtaining buffer information of the media stream comprises:
obtaining a buffer duration of a plurality of data packets corresponding to the audio stream in the media stream in the buffer within a preset time period through a second interface provided by a web side; and
calculating an average buffer duration of the plurality of data packets in the buffer as the buffer information.

19. The electronic device according to claim 18, wherein the adjusting a size of a buffer of the media stream based on the time difference and the buffer information comprises:
calculating a sum of the average buffer duration and the time difference as an adjustment parameter; and
adjusting, by using the adjustment parameter, a size of a buffer corresponding to the video stream in the media stream.

20. The electronic device according to claim 19, wherein the adjusting, by using the adjustment parameter, a size of a buffer corresponding to the video stream in the media stream comprises:
setting the size of the buffer of the media stream by using the adjustment parameter through a third interface provided by the web side.
